(19) United States
(12) Patent Application Publication
(10) Pub. No.: US 2014/0123498 A1
(43) Pub. Date: May 8, 2014

(54) Weed trimmer extension device with collecting bag and weed disperser

(71) Applicant: Charles Raphael Grande, Penn Valley, CA (US)

(72) Inventor: Charles Raphael Grande, Penn Valley, CA (US)

(21) Appl. No.: 14/160,466

(22) Filed: Jan. 21, 2014

Related U.S. Application Data
(63) Continuation-in-part of application No. 14/058,278, filed on Oct. 20, 2013.
(60) Provisional application No. 61/795,665, filed on Oct. 22, 2012.

(51) Int. Cl. A01D 43/063

(52) U.S. Cl. CPC A01D 43/0636
USPC 30/124

(57) ABSTRACT

A weed trimmer extension device for cutting and collecting, or dispersing weeds includes a cutting enclosure, to which can be attached a collecting bag or a cutting disperser. The weed trimmer extension device can be attached to a standard weed trimmer with common fastening components. The cutting enclosure covers a cutting implement, which propels the cuttings, contained and directed by the cutting enclosure, into either the collecting bag or the cutting disperser, which disperses the weed cuttings over an area to the side. A cutting implement can include a cutting blade and a cutting string, so that the cutting string has a greater cutting radius, to allow the cutting string to operate close to an obstruction, without the cutting blade potentially causing damage to the obstruction. Also disclosed is a weed trimmer with a cutting enclosure, to which can be attached either a collecting bag or a cutting disperser.

### CROSS-REFERENCE TO RELATED APPLICATIONS

This application is a continuation-in-part of application Ser. No. 14/058,278, filed Oct. 20, 2013, which is the non-provisional application for U.S. Provisional Application No. 61/795,665, filed Oct. 22, 2012.

### FIELD OF THE INVENTION

The present invention relates generally to the field of weed trimming devices, and more specifically to weed trimming devices that can collect or spread weed cuttings during use.

### BACKGROUND OF THE INVENTION

A weed trimmer, often also referred to as a string trimmer, weed eater, weed whip, weed cutter, or edge trimmer, works on the principle that a line is stretched out from its fast rotating head by centrifugal force, and can thereby cut grass, weed, and thin branches. A weed trimmer can also use a chain trimmer head, metal cutting head, or other lightweight cutting implements. Weed trimmers are characterized by having a cutting implement at the end of a long shaft with a handle or handles. They are designed as relatively lightweight devices for one-hand or two-hand operation, and sometimes can be used in conjunction with a shoulder strap.

Weed trimmers have become very popular since their invention in the early 1970's. However, it has remained a problem that these devices will shed the cutting remains in the immediate area of operation.

Some attempts have been made to implement container devices for the weed cuttings. Most notably, it has been attempted to combine a weed trimmer with a weed vacuum, so that the trimmings will be collected in the weed vacuum bag. These devices suffer from a number of problems, particularly they can become very heavy, and they are ineffective because the weed trimmer operation does not work well in conjunction with the inward suction from the vacuum, causing a tendency for a proportion of the cuttings to be pushed to the side instead of into the vacuum bag. Because of these problems, such devices with container bags have not been adopted widely in the market place.

As such, it may be appreciated that there continues to be a need for novel and improved weed trimming devices that can collect weed cuttings during use.

### SUMMARY OF THE INVENTION

The foregoing needs are met, to a great extent, by the present invention, wherein in aspects of this invention, enhancements are provided to the existing models of weed trimmers.

In various aspects of the invention, a standard weed trimmer can be extended with a component that collects or disperses weed cuttings during use.

In an aspect of this invention, a weed trimmer extension device for cutting and collecting, or dispersing weeds can include a cutting enclosure, to which can be attached a collecting bag or a cutting disperser. The weed trimmer extension device can be attached to a standard weed trimmer.

In a related aspect of this invention, a weed trimmer with collecting bag can include a standard weed trimmer, a cutting enclosure, to which can be attached either a collecting bag or a cutting disperser, so that weeds are driven from the cutting string or device, directed by the cutting enclosure into the cutting bag.

In a related aspect, a cutting implement of the weed trimmer can include a cutting blade and at least one cutting string, so that the cutting string is configured to have a greater perimeter reach, whereby the cutting string can cut grass or weeds close to an obstruction, such as a tree or fence, without the cutting blade touching and potentially causing serious damage to the obstruction.

In a further related aspect, the cutting string can be mounted to the end of the cutting blade.

In a related aspect, the cutting enclosure can be configured with a rim that is mounted on the inside of the upper part of the cutting enclosure; and the cutting implement can be configured with at least one vertical fin, that is mounted perpendicular to the direction of rotation, on an inner side of the cutting implement, between the cutting implement and the cutting enclosure; whereby the vertical fin will create a vortex of air that gets sucked in from underneath the cutting enclosure, and is ejected out via an opening in the rim.

### BRIEF DESCRIPTION OF THE DRAWINGS

FIG. 1 is a perspective view of a weed trimmer extension device, according to an embodiment of the invention.

FIG. 2 is a perspective view of a weed trimmer extension device, according to an embodiment of the invention.

FIG. 3 is a bottom view of a cutting enclosure, according to an embodiment of the invention.

FIG. 4 is a rear view of a cutting enclosure, according to an embodiment of the invention.

FIG. 5 is a bottom view of a cutting enclosure, according to an embodiment of the invention.

FIG. 6 is a perspective view of a weed trimmer extension device, according to an embodiment of the invention.

FIG. 7 is a bottom view of a cutting enclosure, according to an embodiment of the invention.

FIG. 8 is a perspective view of a cutting implement with mounting parts and circular bolt, according to an embodiment of the invention.

FIG. 9 is a rear-side perspective view of a cutting enclosure with cutting disperse, according to an embodiment of the invention.

FIG. 10 is a perspective view of a weed trimmer with collecting bag, according to an embodiment of the invention.

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

Throughout this disclosure, a standard weed trimmer shall be defined to include such devices commonly known as string trimmers, weed eaters, weed whips, weed cutters, edge trimmers, etc. A standard weed trimmer has a rotating cutting implement that can cut with a rotating string, metal wire, or other metal or plastic cutting device. These standard weed trimmers do not have any mechanism or function for retaining the grass cuttings. They are typically powered by an internal combustion or electrical engine.

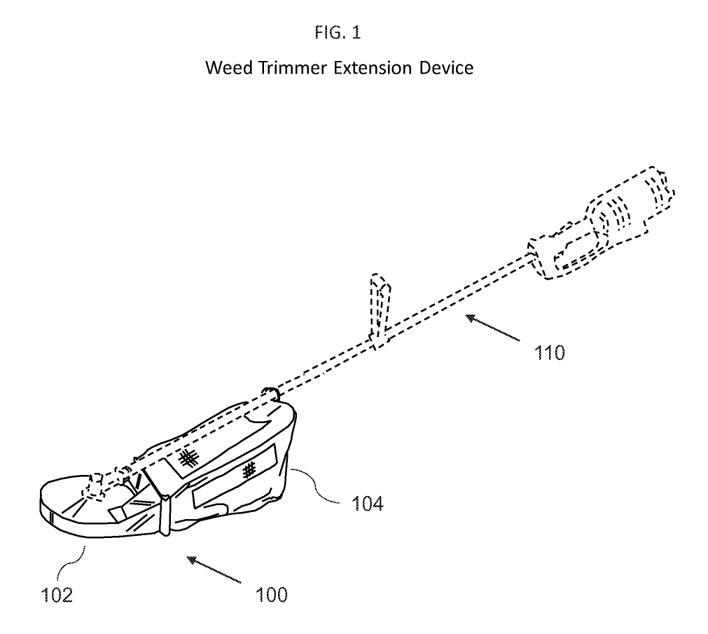

In the following, we describe the structure of an embodiment of a weed trimmer with collecting bag with reference to FIG. 1.

In an embodiment, a weed trimmer extension device 100 for cutting and collecting weeds can include:
a. a cutting enclosure 102; and
b. a collecting bag 104;
wherein the weed trimmer extension device can be attached to a standard weed trimmer 110 with common fastening components, and the cutting enclosure 102 can cover a cutting implement of the standard weed trimmer and the cutting implement propels the cuttings, which are contained and directed by the cutting enclosure 102, into the collecting bag 104.

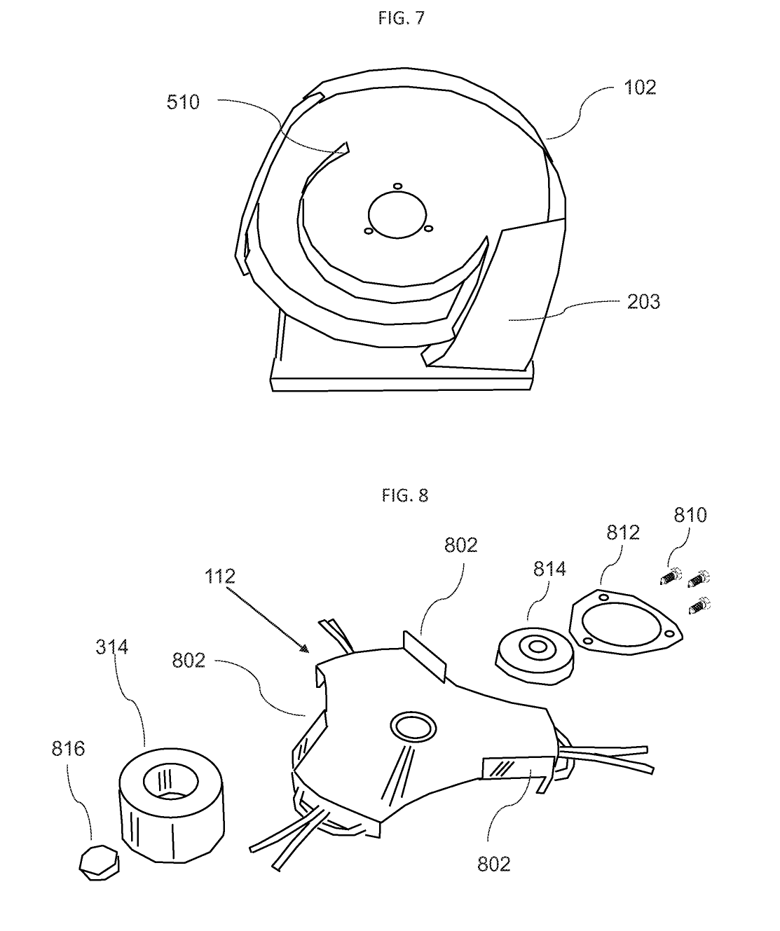

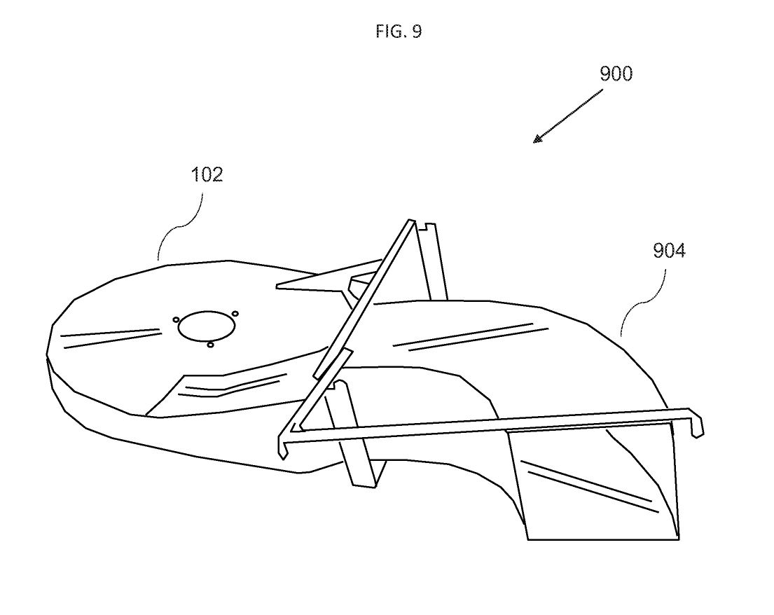

In related embodiments, common fastening components are bolts and other types of fasteners that are well known as fastening components to attach a cutting implement to an axle on common weed trimmers. FIG. 8 shows an example of common fastening components, including fastening bolts 810, and a washer 812, for attaching the cutting enclosure 102 to the standard cutting head of the standard weed trimmer. Also shown are a separator 814, for separating the cutting implement from the top of the cutting enclosure 102, and an end-bolt 816, for securing the cutting implement to the axle of the cutting head of the standard weed trimmer.

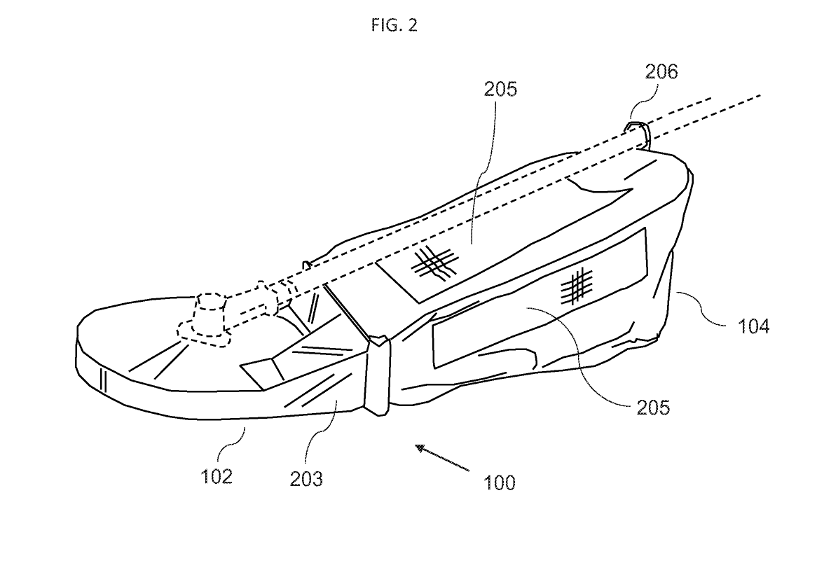

In a related embodiment, as shown in FIG. 2, the cutting enclosure 102 can further include an ejection canal 203 for ejecting the cuttings from the cutting enclosure 102.

In a related embodiment, the collection bag 104 can include one or more mesh screens 205, which can be made of a mesh fabric that will allow airflow, so that air pressure can be reduced when air enters the collection bag 104 from the ejection canal 203 during operation. The mesh screen 205 thereby can function to avoid or reduce pressure accumulation in the collection bag 104, which could decrease cutting effectiveness, and the mesh screen 205 can also allow a user to visually inspect the contents of cuttings in the collection bag 104. As shown in FIG. 2, the collection bag 104 can for example include mesh screens 205 on both the top and sides.

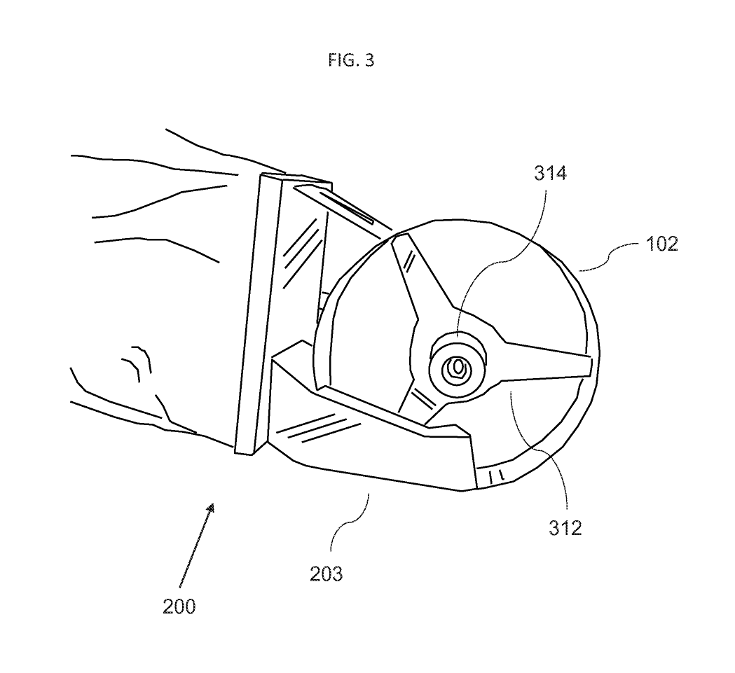

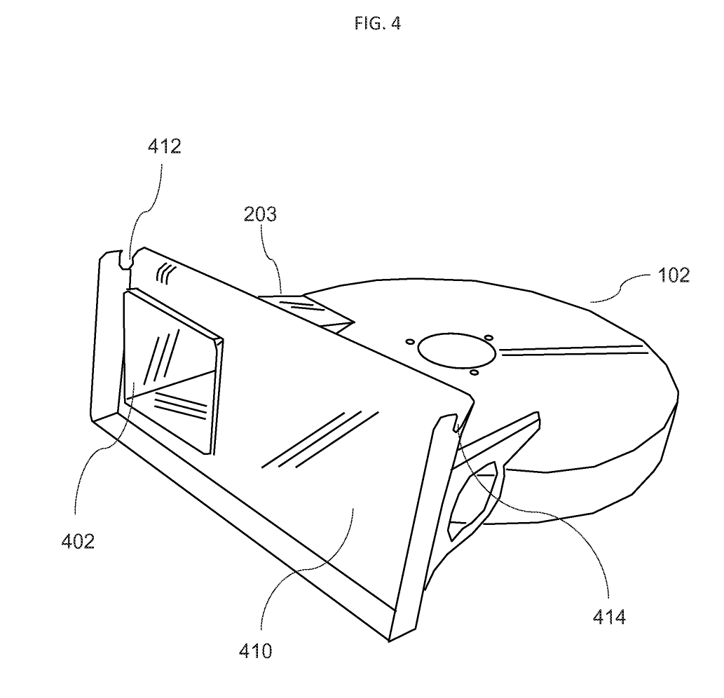

In a related embodiment, FIG. 3 shows an underside view of the cutting enclosure 102. The cutting implement 312 can either be a standard cutting implement, which is a part of the standard weed trimmer 110, or can be a replacement cutting implement that is a part of the weed trimmer extension device 100. The cutting implement 312 can rotate clockwise, when viewed from below, creating an air vortex, which drives cuttings through the ejection canal through an ejection aperture 402, as shown on FIG. 4, whereby the cutting are ejected out of the cutting enclosure into the connecting collecting bag 104.

In a related embodiment, shown in FIG. 3, the cutting implement 312 can be mounted with a circular bolt 314, which protrudes underneath the cutting implement 312, to prevent close contact with the ground, thereby reducing the strength of the air vortex, to limit the risk of stones being picked up, and also reduce the risk of the cutting implement 312 impacting the ground during use.

In a related embodiment, FIG. 4 shows a rear view of the cutting enclosure, further including an end plate 410, which connects to the collecting bag 104, and further including the ejection aperture 402, at the end of the ejection canal 203.

In a related embodiment, the end plate 410 can further include notches 412 414, in both top corners, or other fastening mechanisms, for attaching the collecting bag 104 to the end plate 410 of the cutting enclosure 102.

In a related embodiment, as illustrated in FIG. 2, the collection bag 104 can include a bag fastener 206 for securing the collection bag to the shaft of the standard weed trimmer 110. The bag fastener 206 can include:
a. a fastening hook, for example made of metal;
b. a fastening strap, for example made of a strong fabric, and further utilizing a hook and loop material to secure the fastening strap in place; or
c. other common fastening mechanisms.

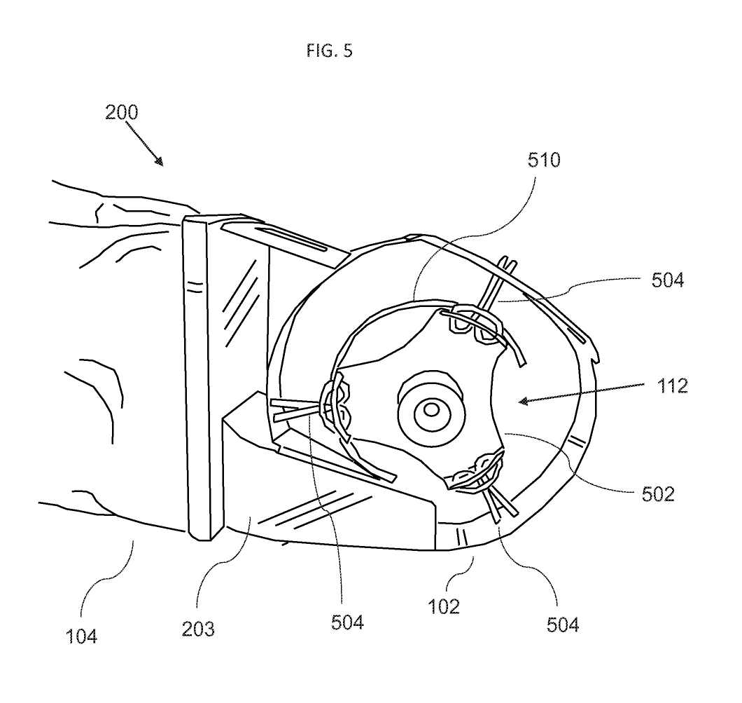

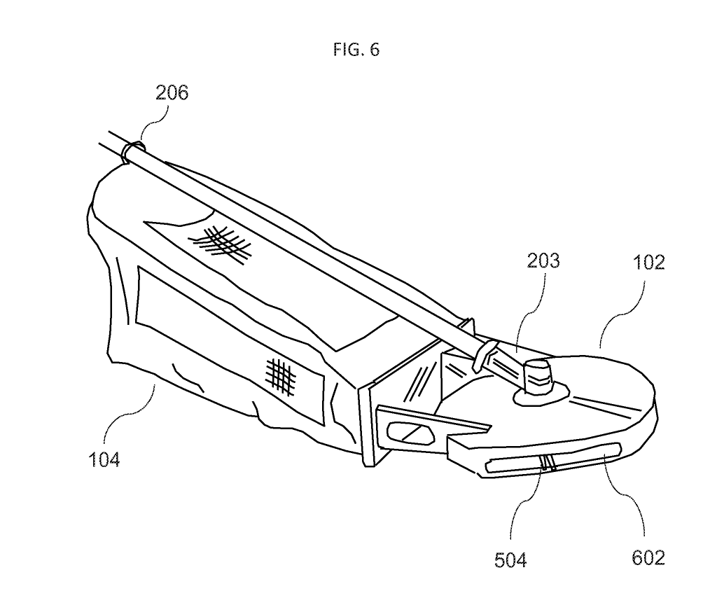

In a related embodiment, illustrated in FIG. 5, the cutting implement 112 can be further comprised of a cutting blade 502, and one or more cutting strings 504, wherein the cutting string 504 is configured to have a greater cutting radius than the cutting blade 502, extending with a greater radius in its circular sweep from the rotating axle in the center of the cutting enclosure, whereby the cutting string can cut grass close to an obstruction, such as a tree or fence, without the cutting blade touching and potentially causing serious damage to the obstruction.

In a further related embodiment, the cutting string 504 can be mounted to the end of the cutting blade 502, for example by being looped through holes in a flank at the end of the cutting blade, such as illustrated in FIG. 5.

In a further related embodiment, the tip of the cutting strings 504 can be configured to extend beyond a segment of the sidewall of the cutting enclosure 102, and during rotation protrude through a sidewall aperture 602 in the segment of the sidewall, which has been straightened to fit inside the full radius of the generally circular sidewall.

In a further related embodiment, as shown in FIGS. 5 and 7, the cutting blade 502, can rotate inside the perimeter of a circular two thirds rim 510 that is mounted on the inside of the upper part of the cutting enclosure 102, starting from the beginning inside sidewall of the ejection canal. The cutting blade 502 can further have mounted one or more vertical fins 802, as shown in FIG. 8, that are mounted perpendicular to the direction of rotation, on the inner side of the cutting blade 502, so that the vertical fins 802 will strengthen the vortex of air that gets sucked in from underneath the cutting enclosure 102, and is ejected out via the ejection canal 203.

In an alternative embodiment, illustrated in FIG. 9, a weed trimmer extension device 900 for cutting and dispersing weeds can include:
a. a cutting enclosure 102; and
b. a cutting disperser 904;
wherein the weed trimmer extension device can be attached to a standard weed trimmer 110 with common fastening components, and the cutting enclosure 102 can cover a cutting implement of the standard weed trimmer and the cutting implement propels cuttings, which are contained and directed by the cutting enclosure 102, into the cutting disperser, which directs and disperses the cuttings. The cutting disperser 904 is shown mounted to disperse cuttings to an area on the left side of the weed trimmer extension device, but can also be mounted to disperse cuttings to the right side.

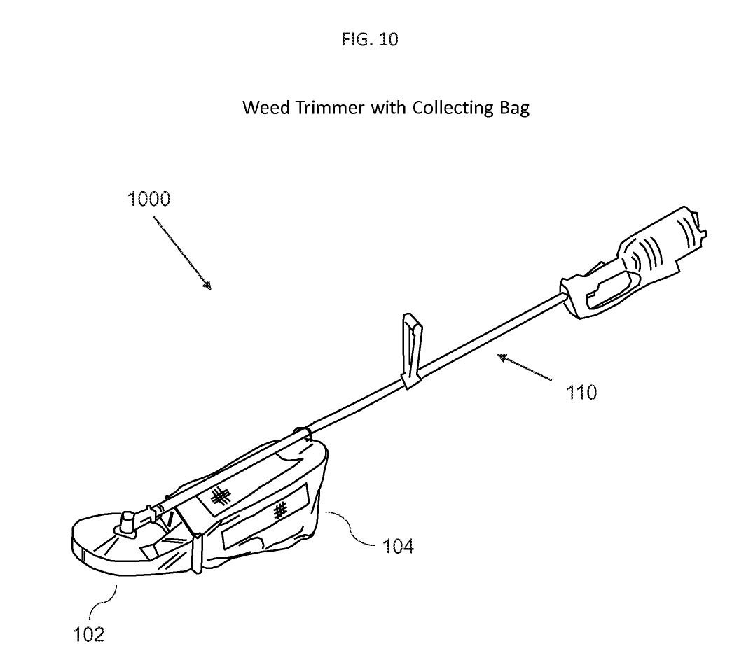

In an embodiment, shown in FIG. 10, a weed trimmer with collecting bag 1000 for cutting and collecting weeds can include:
a. A standard weed trimmer 110, further comprising:
   i. A cutting implement 112;
b. a cutting enclosure 102; to which can be mounted either a
c. a collecting bag 104;
   wherein the cutting enclosure 102 fits over and covers the cutting implement 112, and the cutting implement 112 propels cuttings, which are contained and directed by the cutting enclosure 102, into the collecting bag 104, or
d. a cutting disperser 904;

In related embodiments, the cutting enclosure 102 can be made of a plastic material, or metal, including suitable alloys, each respectively of a suitable thickness and strength, well known in the manufacturing of common shields for cutting heads of standard weed-trimmers. For example, a gauge 13 sheet metal, such as a 3/32 inch steel plate can be used.

In a related embodiment, the collecting bag 104 can be made of a fabric or a plastic material, each respectively of a suitable flexibility, thickness, and strength. A suitable fabric material can for example be a canvas material made of cotton or linen.

Here has thus been described embodiments of the weed trimmer with collecting bag device, and methods related thereto, which can be employed in numerous modes of usage.

The many features and advantages of the multitude of embodiments of the weed trimmer with collecting bag are apparent from the detailed specification, and thus, it is intended by the appended claims to cover all such features and advantages of the invention, which fall within the true spirit and scope of the invention.

Many such alternative configurations are readily apparent, and should be considered fully included in this specification and the claims appended hereto. Accordingly, since numerous modifications and variations will readily occur to those skilled in the art, it is not desired to limit the invention to the exact construction and operation illustrated and described, and thus, all suitable modifications and equivalents may be resorted to, falling within the scope of the invention.

What is claimed is:

1. A weed trimmer extension device, comprising a cutting enclosure, wherein the cutting enclosure can be attached to a standard weed trimmer with common fastening components, and the cutting enclosure can cover a cutting implement, which creates an air vortex that propels cuttings, which are contained and directed by the cutting enclosure, and wherein the cuttings are ejected through an ejection aperture in a side of a rear end of the cutting enclosure.

2. The weed trimmer extension device of claim 1, wherein the cutting implement is a standard cutting element, which is a part of the standard weed trimmer.

3. The weed trimmer extension device of claim 1, further comprising a replacement cutting element, wherein the replacement cutting element is mounted on the standard weed trimmer, and replaces a standard cutting element.

4. The weed trimmer extension device of claim 1, wherein the cutting enclosure further comprises an ejection canal, whereby the ejection canal can direct and eject the cuttings from the cutting enclosure to the ejection aperture in the side of the rear end of the cutting enclosure.

5. The weed trimmer extension device of claim 1, wherein the cutting implement is mounted with a circular bolt, wherein the circular bolt protrudes underneath the cutting implement to prevent close contact with the ground, whereby the strength of the air vortex is reduced, and the risk of the cutting implement impacting ground during use is minimized.

6. The weed trimmer extension device of claim 3, wherein the replacement cutting implement is further comprised of:
a) a cutting blade; and
b) at least one cutting string;
wherein the cutting string is configured to have a greater cutting radius than the cutting blade, whereby the cutting string can cut weeds and grass close to an obstruction, without the cutting blade touching and potentially causing damage to the obstruction.

7. The weed trimmer extension device of claim 6, wherein the cutting string is mounted to the end of the cutting blade.

8. The weed trimmer extension device of claim 6, wherein the cutting string is configured to extend beyond a sidewall of the cutting enclosure, and during rotation protrude through a sidewall aperture in a segment of the sidewall, wherein the segment has been straightened to fit inside the full radius of the sidewall.

9. The weed trimmer extension device of claim 1, wherein
a) the cutting enclosure is further configured with a rim that is mounted on the inside of an upper part of the cutting enclosure; and
b) the cutting implement is further configured with at least one vertical fin, that is mounted perpendicular to the direction of rotation, on an inner side of the cutting implement, between the cutting implement and the cutting enclosure;
wherein the vertical fin will strengthen the vortex of air that gets sucked in from underneath the cutting enclosure, and is ejected out via an opening in the rim, in direction towards the ejection aperture.

10. The weed trimmer extension device of claim 1, further comprising a collection bag, wherein the collection bag can be attached to the cutting enclosure, and wherein the cutting implement propels the cuttings, which are contained and directed by the cutting enclosure, through the ejection aperture and into the collecting bag.

11. The weed trimmer extension device of claim 10, wherein the collection bag further comprises at least one mesh screen, made of a mesh fabric that allows airflow, whereby air pressure is reduced when air enters the collection bag from the cutting enclosure during operation, and the mesh screen thereby can function to avoid or reduce pressure accumulation in the collection bag, and can allow a user to visually inspect the contents of cuttings in the collection bag.

12. The weed trimmer extension device of claim 1, further comprising a cutting disperser, wherein the cutting disperser can be attached to the cutting enclosure and the standard weed trimmer, and the cutting implement propels cuttings, which are contained and directed by the cutting enclosure, through the ejection aperture and into the cutting disperser, which directs and disperses the cuttings to an area to a side of the weed trimmer extension device during operation.

13. A weed trimmer, comprising:
a) a standard weed trimmer; and
b) a cutting enclosure;
wherein the cutting enclosure can be attached to the standard weed trimmer with common fastening components; and the cutting enclosure can cover a cutting implement, which creates an air vortex that propels cuttings, which are contained and directed by the cutting enclosure; and wherein the cuttings are ejected through an ejection aperture in a side of a rear end of the cutting enclosure.

14. The weed trimmer of claim 13, wherein the cutting implement is mounted with a circular bolt, wherein the circular bolt protrudes underneath the cutting implement to prevent close contact with the ground, whereby the strength of the air vortex is reduced, and the risk of the cutting implement impacting ground during use is minimized.

15. The weed trimmer of claim 13, wherein the cutting implement is further comprised of:
a) a cutting blade; and
b) at least one cutting string;
wherein the cutting string is configured to have a greater cutting radius than the cutting blade, whereby the cutting string can cut weeds and grass close to an obstruction, without the cutting blade touching and potentially causing damage to the obstruction.

16. The weed trimmer of claim 15, wherein the cutting string is mounted to the end of the cutting blade.

17. The weed trimmer of claim 15, wherein the cutting string is configured to extend beyond a sidewall of the cutting enclosure, and during rotation protrude through a sidewall aperture in a segment of the sidewall, wherein the segment has been straightened to fit inside the full radius of the sidewall.

18. The weed trimmer of claim 13, wherein
a) the cutting enclosure is further configured with a rim that is mounted on the inside of an upper part of the cutting enclosure; and
b) the cutting implement is further configured with at least one vertical fin, that is mounted perpendicular to the direction of rotation, on an inner side of the cutting implement, between the cutting implement and the cutting enclosure;
wherein the vertical fin will strengthen the vortex of air that is sucked in from underneath the cutting enclosure, and is ejected out via an opening in the rim, in direction towards the ejection aperture.

19. The weed trimmer of claim 13, further comprising a collection bag, wherein the collection bag can be attached to the cutting enclosure, and wherein the cutting implement propels the cuttings, which are contained and directed by the cutting enclosure, through the ejection aperture and into the collecting bag.

20. The weed trimmer of claim 13, further comprising a cutting disperser, wherein the collection bag can be attached to the cutting enclosure and the standard weed trimmer, and the cutting implement propels cuttings, which are contained and directed by the cutting enclosure, through the ejection aperture and into the cutting disperser, which directs and disperses the cuttings to an area to a side of the weed trimmer extension device during operation.
